(19) United States
(12) Patent Application Publication
(10) Pub. No.: US 2006/0053297 A1
(43) Pub. Date: Mar. 9, 2006

(54) System and method for protecting equipment data

(76) Inventors: Chien Chung Huang, Taichung City (TW); Yi-Lin Huang, Keelung City (TW); Wen-Chang Kuo, Hsinchu City (TW); Bing-Hung Lin, Xindian City (TW); Yueh-Ching Lee, Jhongli City (TW); Hui Wen Yang, Taichung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/934,237

(22) Filed: Sep. 3, 2004

(51) Int. Cl. H04L 9/00; H04K 1/00

(52) U.S. Cl. 713/182

(57) ABSTRACT

Processing equipment for protecting equipment data. A processing unit processes an article, such as a wafer. A storage unit stores equipment data for the processing unit. A controlling unit receives a data retrieval request for the equipment data, wherein the data retrieval request comprises identification data. An authentication unit validates the identification data and retrieves corresponding equipment data form the storage unit through the controlling unit, when the identification data is validated. An encryption unit receives the equipment data from the authentication unit, and encrypts the equipment data. A controlling unit further transfers the encrypted equipment data to an external system.

### BACKGROUND

The present invention relates to data protection and particularly to processing equipment equipped with security mechanisms.

Semiconductors are typically mass produced from silicon wafers. A silicon wafer is processed by a sequence of various processing steps, such as deposition, photolithography, etch, etc. Wafers processed in a fab also undergo various tests and measurements for conformance with original design and process requirements. Various wafer inspection, metrology, test, and measurements tools are used. Each of these semiconductor-processing, inspection, metrology, and measurement machines requires a set of equipment data, such as operating instructions (processing programs or recipes, process logs, equipment constants, etc.), digital data, trend charts, parameters, and so on. Recipes and parameters vary with different kinds of machines, as do recipes and parameters of the same kind of machines made by different machine manufacturers.

Similarly, a liquid-crystal display (LCD) is processed by a sequence of various steps. LCDs generally undergo three kinds of processes, array processes, cell processes, and module assembly processes. Among these various LCD processes, array processes are similar to semiconductor manufacturing processes, except that in array processes transistors are fabricated on a glass substrate instead of a silicon wafer. Similar to that in the semiconductor industry, each LCD processing machine requires a set of equipment data, such as operating instructions (processing programs or recipes, process logs, equipment constants, etc.), digital data, trend charts, parameters, and so on. Recipes and parameters vary with different kinds of machines, as do recipes and parameters of the same kind of machines made by different machine manufacturers.

Equipment data can become quite complex and very diverse as process engineers attempt to refine the process for desired results. Different semiconductor/LCD products may require operation instructions, including different recipes, different steps, or different combinations of steps, or may generate different measurement data and parameters. Such process and measurement data are very important for perfecting a manufacturing process, and numerous resources are expended to obtain optimized equipment data. Such optimized equipment data are invaluable assets of a wafer manufacturing company, or a LCD manufacturing company.

The equipment data, however, is not well protected and thus susceptible to unauthorized distribution. As an example, FIG. 1 is a schematic view showing a conventional semiconductor manufacturing system, but it should be understood that the same drawback is true in many other industries such as LCD (Liquid Crystal Display), IC package, IC testing, and so on, although the manufacturing system may not be exactly the same as the shown example. A manufacturing system 10 typically comprises a tool 11 and a host system 15. Tool 11, as an example, comprises a storage unit 113, a processing unit 111, and a controlling unit 115. The storage unit 113 stores equipment data for processing unit 111. The processing unit 111 processes a wafer (or a display panel in an LCD industry, or an IC in an IC package/testing industry) according to the equipment data. The term “processing” used herein is in a broad sense, which may be performing a manufacturing step, or a measurement step. The controller unit 115 provides an interface for host system 15 and other external device 19. Any user can request equipment data through controlling unit 115, which retrieves and transfers equipment data in unprotected form accordingly. The equipment data is transferred to the host system 15 in its original form without any protection. Anyone accessing tool 11 can acquire an electronic copy of the equipment data, and distribute it through any device equipped with a memory. Similarly, anyone accessing the host system 15 can duplicate the equipment data and distribute it easily.

### SUMMARY

Embodiments of the present invention provide processing equipment equipped with a security system for managing distribution of equipment data. By implementing authentication and/or encryption mechanisms, the security system protects equipment data.

According to one embodiment, processing equipment having equipment data protection is provided. The processing equipment contains a processing unit, a storage unit, a controlling unit, and an authentication unit. The processing unit processes an article, such as a wafer, a display panel, an IC, etc. The storage unit stores equipment data for the processing unit. The controlling unit receives a data retrieval request for the equipment data, wherein the data retrieval request comprises identification data. The authentication unit validates the identification data and causes the controlling unit to retrieve corresponding equipment data from the storage unit, when the identification data is validated. The controlling unit further transfers the equipment data to an external system.

According to another embodiment, processing equipment having equipment data protection is provided. The processing equipment contains a processing unit, a storage unit, a controlling unit, and an encryption unit. The processing unit processes an article, such as a wafer, a display panel, an IC, etc. The storage unit stores equipment data for the processing unit. The controlling unit receives a data retrieval request from an external unit for the equipment data, wherein the data retrieval request preferably comprises identification data. The encryption unit receives the equipment data from the storage unit, and encrypts the equipment data. The controlling unit further transfers the equipment data to the external unit.

According to another embodiment, a manufacturing system is provided. The manufacturing system comprises processing equipment and an authentication unit external to the processing equipment. The processing equipment comprises a processing unit, a storage unit, and a controlling unit. The storage unit stores equipment data thereof. The controlling unit receives a first request for the equipment data, wherein the first request comprises identification data. The authentication unit validates the identification data and causes the controlling unit to retrieve the corresponding equipment data from the storage unit when the identification data is validated.

According to still another embodiment, a manufacturing system is provided. The manufacturing system comprises processing equipment and an encryption unit external to the processing equipment. The processing equipment comprises a processing unit, a storage unit, and a controlling unit. The storage unit stores equipment data thereof. The controlling unit receives a first request from an external unit for the equipment data, wherein the first request preferably comprises identification data. The encryption unit encrypts the equipment data before the data is sent out to the external requesting unit.

Also provided is an electronic device, which is processed by processing equipment comprising equipment data protection. The electronic device is a semiconductor device or a liquid crystal display panel.

Also provided is a method of managing equipment data distribution, which can be implemented in the aforementioned system. A data retrieval request for the equipment data is received, wherein the data retrieval request comprises identification data. The identification data is then validated. When the identification data is validated, the equipment data is retrieved from the storage unit and encrypted. The encrypted equipment data is then transferred to an external system.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view of a conventional manufacturing system;

FIG. 2 is a schematic view showing a manufacturing system according to embodiments of the present invention; and

FIGS. 3A and 3B illustrate a method of managing equipment data distribution according to embodiments of the present invention.

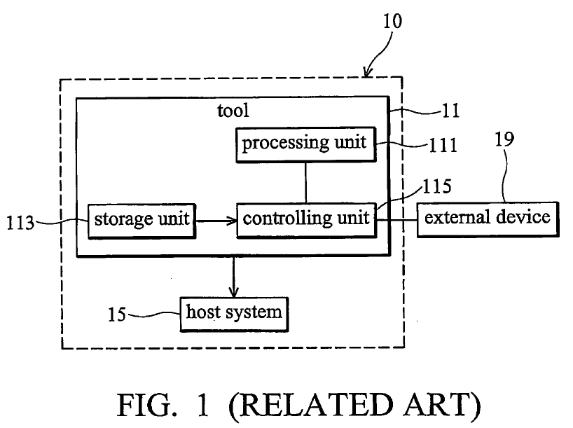

### DETAILED DESCRIPTION

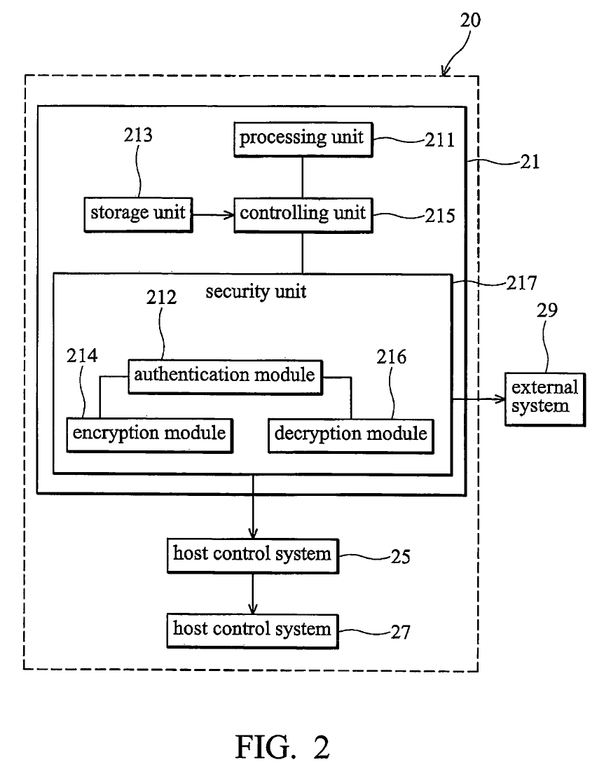

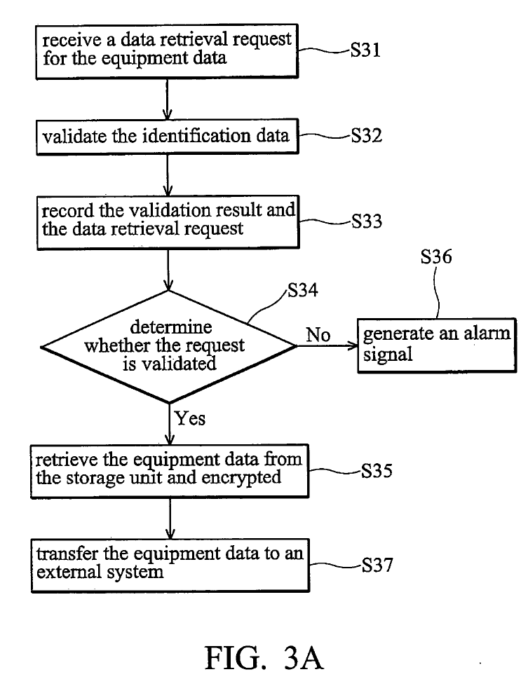

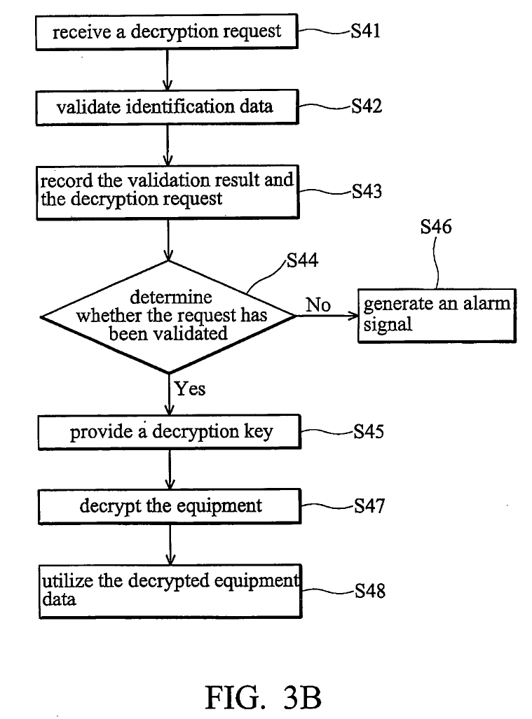

The disclosure references FIGS. 2 to 3, which in general relate to processing equipment equipped with a security system for managing distribution of equipment data thereof. While the disclosure refers to a semiconductor manufacturing environment, it is understood that any processing equipment having equipment data stored within an internal memory thereof may operate with the embodiments disclose.

FIG. 2 is a schematic view showing a manufacturing system according to embodiments of the present invention.

A manufacturing system 20 comprises processing equipment 21 and a host control system 25. Processing equipment 21 comprises a processing unit 211, a storage unit 213, a controlling unit 215, and a security unit 217. The security unit 217 preferably comprises an authentication module 212, an encryption module 214, and a decryption module 216. It is to be understood that the security unit 217 may only comprise the authentication module 212, but without the encryption module 214 and the decryption module 216, or only comprise the encryption module 214, but without the authentication module 212 and the decryption module 216.

Processing unit 211 processes a wafer, an IC, or an LCD panel according to, for example, manufacturing, testing, or packaging.

Storage unit 213 stores equipment data for processing unit 211. The equipment data comprises data pertaining to operation of processing equipment 21, such as operating instructions (processing programs or recipes, process logs, equipment constants, etc.), digital data, trend charts, and/or parameters. The equipment data can be stored in encrypted form or original form. When the equipment data is stored in encrypted form, it is decrypted before the processing equipment utilizes it, and transmitted to outside device in the encrypted form. When the equipment data is stored in its original form, it can be utilized directly within the processing equipment, and encrypted before it is transmitted to an outside device.

The controlling unit 215 communicates with host control system 27 and external system 29. The host control system 27 comprises a shop floor control system in a semiconductor manufacturing environment, such as a host computer, a manufacturing executive system (MES), or recipe management system. The external system can be any device capable of storing data. The controlling unit 215 receives a data retrieval request for the equipment data, the request comprising identification data. When the data retrieval request is received and the identification data is validated, authentication module 212 validates the identification data and retrieves corresponding equipment data from the storage unit 213 through the controlling unit 215. If the identification data is invalidated, authentication module 212 generates an alarm signal. After the equipment data is retrieved from the storage unit 213, it is further processed by the encryption module 214 into an encrypted form. The encrypted equipment data is then relayed to controlling unit 215, and provided to host control system or external system 29 accordingly.

When the encrypted equipment data needs to be decrypted, a decryption request is issued and sent to the authentication module 212. Similarly, the decryption request comprises identification data, and the identification data is validated by the authentication module 212. The authentication module 212 validates the identification data specified in the decryption request. When the identification data is validated, the authentication module 212 provides corresponding decryption key, or issues an approval for another source (not shown) to provide the corresponding decryption key. When the identification data is invalidated, authentication module 212 generates an alarm signal. Preferably, the authentication module 212 also retains a record of every data retrieving and decryption request, such that every action to retrieve or decrypt the equipment data is recorded and can be traced through any known method.

The security unit 217 and components thereof can be arranged in different ways. For example, according to one embodiment, the security unit 217 may only comprise the authentication module, while the encryption and/or decryption functions on the equipment data are not performed, or performed by encryption and/or decryption modules external to the processing equipment. The authentication module validates the identification data, and causes the controlling unit to retrieve corresponding equipment data from the storage unit, when the identification data is validated. The controlling unit further transfers the equipment data to an external system.

According to another embodiment, the security unit 217 may only comprise the encryption module, while the authentication function is performed optionally. Any equipment data that is transferred to an external unit is encrypted. Decryption of the data may be performed by a decryption module external to the processing equipment 21, which may be part of a centralized data security management unit (not shown), or performed by a decryption module embedded in the external unit which requests for the equipment data, such as the external system 29. When data is decrypted at the external requesting unit, the decryption key may be provided from the centralized data security management unit, or the external requesting unit has the key if it is a legitimate user of the data. The external requesting unit may be a processing equipment similar to the processing equipment 21, located at the same fab or at a different fab. In other words, there may be at least one “mother” processing equipment 21 which contains the equipment data and embedded with an encryption module 213, and one or more “daughter” processing equipment which intend to copy the equipment data and embedded with a decryption module 214. When the external requesting unit is not a legitimate user of the equipment data, the illegal external unit will not be able to decrypt the equipment data because it does not have the decryption key itself, nor can it get the key from the centralized data security management unit. According to another embodiment, a manufacturing system is provided. The manufacturing system comprises processing equipment and a security unit external to the processing equipment. In this embodiment, the security unit 217 is not part of the process equipment, but is an external unit to the processing equipment. The security unit is an isolated unit, or may be part of a centralized data security management unit (not shown). The security unit 217 comprises the authentication module, or the encryption module, or both. Preferably it further comprises a decryption module together with the encryption module. In addition, since the equipment data may usually be in the form of raw digital data which is not comprehensible by human being, the manufacturing system may further include a content management system (not shown) which generates a technical document, or an operation instruction, or other documents/data sheets, based on the equipment data.

FIGS. 3A and 3B are flowcharts of a method of managing equipment data distribution according to embodiments of the invention. The method can be implemented in the system of FIG. 2.

Using FIG. 3A as an example, a data retrieval request for the equipment data is received (step S31), wherein the data retrieval request comprises identification data. The equipment data comprises data pertaining to operation of processing equipment, such as recipe data or equipment parameters. The data retrieval request may come from any source, such as a host control system of a manufacturing system, or duplicating of the equipment data into a storage device outside the processing equipment.

The identification data is validated (step S32). The validation result and the data retrieval request are recorded (step S33). Next, it is determined whether the request is validated (step S34), and if so, the equipment data is retrieved from the storage unit and encrypted (step S35). The equipment data can be stored in encrypted form or original form. When the equipment data is stored in encrypted form, it is decrypted before the processing equipment utilizes it, and transmitted to outside device in the encrypted form. When the equipment data is stored in its original form, it can be utilized directly within the processing equipment, and encrypted before it is transmitted to an outside device. The encrypted equipment data is then transferred to an external system (step S37). If the data retrieval request is invalidated, an alarm signal is generated (step S36).

Referring to FIG. 3B, when encrypted data is utilized for further function, it must be first decrypted. To achieve a decryption key for the encrypted equipment data, a decryption request is issued and received by the authentication module 212 of FIG. 2 (step S41). The decryption request seeks a decryption key for decrypting the encrypted equipment data. The decryption request comprises identification data. The identification data specified in the decryption request is then validated (step S42). The validation result and the decryption request are then recorded (step S43). It is then determined whether the request has been validated (step S44), and if so, a corresponding decryption key is provided (step S45). If the decryption request is invalidated, an alarm signal is generated (step S46). The encrypted equipment is decrypted using the decryption key (step S47). The decrypted equipment data can be utilized in several ways (step s48). For example, the decrypted equipment data can be loaded into other processing equipment or a content management system. When loaded in processing equipment, the equipment data can direct equipment operation. When loaded into content management, the equipment data can generate a technical document or operating instructions. Further utilization of the decrypted equipment data is not limited to those mentioned and can be used in any way to meet special needs.

While the disclosure refers to a semiconductor manufacturing environment, it is understood that any processing equipment having equipment data stored within an internal memory thereof may operate with the embodiments disclosed. It is to be understood that the invention may be applicable to various industries such as, but not limited to, wafer manufacture, IC package, and LCD.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. Processing equipment comprising equipment data protection, comprising:
a processing unit;
a storage unit storing equipment data for the processing unit;
a controlling unit receiving a first request for the equipment data, wherein the first request comprises identification data; and
an authentication unit validating the identification data, causing the controlling unit retrieving corresponding equipment data from the storage unit when the identification data is validated.

2. The processing equipment of claim 1, wherein the processing unit processes one of a wafer, an IC chip, and a liquid crystal display panel.

3. The processing equipment of claim 1, wherein the equipment data comprises one or more of the followings: recipe data, equipment parameters, processing programs, process logs.

4. The processing equipment of claim 1, wherein the storage unit stores the equipment data in encrypted form.

5. The processing equipment of claim 4, wherein the controlling unit further transfers the equipment data in encrypted form to an external system.

6. The processing equipment of claim 5, wherein the external system comprises one of an external storage device and a shop floor control system in a manufacturing environment.

7. The processing equipment of claim 1, further comprising an encryption unit encrypting the equipment data.

8. The processing equipment of claim 7, wherein the controlling unit further transfers the equipment data in encrypted form to an external system.

9. The processing equipment of claim 7, wherein the external system comprises one of an external storage device and shop floor control system in a manufacturing environment.

10. The processing equipment of claim 5, wherein the authentication unit further receives a second request for a decryption key for the equipment data, and validates the second request.

11. The processing equipment of claim 10, wherein the authentication unit further retains a record of the first and second requests.

12. The processing equipment of claim 10, wherein the authentication unit further generates an alarm signal when receiving an invalidated request.

13. The processing equipment of claim 1, further comprising a decryption unit decrypting the equipment data.

14. A manufacturing system, comprising:
processing equipment comprising:
a processing unit;
a storage unit storing equipment data thereof; and
a controlling unit receiving a first request for the equipment data, wherein the first request comprises identification data; and
an authentication unit validating the identification data and causing the controlling unit to retrieve the corresponding equipment data from the storage unit when the identification data is validated.

15. The manufacturing system of claim 14, further comprising an encryption unit, and encrypting the equipment data.

16. The manufacturing system of claim 14, further comprising a content management system retrieving the equipment data.

17. The manufacturing system of claim 16, wherein the content management system further utilizes the equipment data to generate a technical document.

18. The manufacturing system of claim 16, wherein the content management system further utilizes the equipment data to generate an operating instruction.

19. The manufacturing system of claim 15, wherein the controlling unit further transfers the equipment data to an external system.

20. The manufacturing system of claim 14, wherein the storage unit stores the equipment data in encrypted form.

21. The manufacturing system of claim 14, wherein the authentication unit further receives a second request for a decryption key for the equipment data, validates the second request, and provides the decryption key.

22. The manufacturing system of claim 21, wherein the authentication unit further retains a record of the first and second requests.

23. The manufacturing system of claim 21, wherein the authentication unit further generates an alarm signal when receiving an invalidated request.

24. The manufacturing system of claim 14, further comprising a manufacture executing system (MES).

25. The manufacturing system of claim 14, further comprising a recipe management system.

26. Processing equipment comprising equipment data protection, comprising:
a processing unit;
a storage unit storing equipment data for the processing unit;
a controlling unit receiving a first request for the equipment data, wherein the first request comprises identification data; and
an encryption unit encrypting the equipment data.

27. The processing equipment of claim 26, wherein the equipment data comprises one or more of the followings: recipe data, equipment parameters, processing programs, process logs.

28. The processing equipment of claim 26, wherein the processing unit processes one of the followings: a wafer, an IC, and a liquid crystal display panel.

29. The processing equipment of claim 26, wherein the storage unit stores the equipment data in encrypted form.

30. The processing equipment of claim 29, wherein the controlling unit further transfers the equipment data in encrypted form to an external system.

31. The processing equipment of claim 26, wherein the controlling unit further receives a second request for a decryption key for the equipment data, wherein the second request comprises identification data.

32. The processing equipment of claim 26, further comprising a decryption unit decrypting the encrypted equipment data using corresponding decryption key.

33. A manufacturing system, comprising:
processing equipment comprising:
a processing unit;
a storage unit storing equipment data thereof; and
a controlling unit receiving a first request for the equipment data; and
an encryption unit encrypting the equipment data.

34. The manufacturing system of claim 33, wherein the controlling unit further transfers the equipment data in encrypted form to an external system.

35. The manufacturing system of claim 33, wherein the controlling unit further receives a second request for a decryption key for the equipment data, wherein the second request comprises identification data.

36. The manufacturing system of claim 33, further comprising an authentication unit validating the identification data.

37. The manufacturing system of claim 33, further comprising a decryption unit decrypting the equipment data using corresponding decryption key.

38. An electronic device, which is processed according to equipment data of first processing equipment comprising equipment data protection, wherein the first processing equipment comprises:
a processing unit;
a storage unit storing equipment data for the processing unit;
a controlling unit receiving a first request for the equipment data, wherein the first request comprises identification data; and
an authentication unit validating the identification data, causing the controlling unit retrieving corresponding equipment data from the storage unit when the identification data is validated.

39. The electronic device of claim 38, wherein the electric device is a semiconductor device, an IC, or a liquid crystal display panel.

40. The electronic device of claim 38, wherein the storage unit stores the equipment data in encrypted form.

41. The electronic device of claim 38, wherein the controlling unit further comprises an encryption unit encrypting the equipment data.

42. The electronic device of claim 38, wherein the authentication unit further receives a second request for a decryption key for the equipment data, and validates the second request.

43. The electronic device of claim 42, wherein the authentication unit further retains a record of the first and second requests.

44. The electronic device of claim 38, wherein the first processing equipment further comprises a decryption unit decrypting the encrypted equipment data.

45. The electronic device of claim 38, wherein the electronic device is processed by the first processing equipment.

46. The electronic device of claim 38, wherein the electronic device is processed by second processing equipment which obtains equipment data from the first processing equipment.

47. An electronic device, which is processed according to equipment data of first processing equipment, wherein the first processing equipment comprises:
a processing unit;
a storage unit storing equipment data for the processing unit;
a controlling unit receiving a first request for the equipment data; and
an encryption unit encrypting the equipment data.

48. The electronic device of claim 47, wherein the electric device is a semiconductor device, an IC, or a liquid crystal display panel.

49. The electronic device of claim 47, wherein the storage unit stores the equipment data in encrypted form.

50. The electronic device of claim 47, wherein the authentication unit further retains a record of the first request.

51. The electronic device of claim 47, wherein the first processing equipment further comprises a decryption unit decrypting the encrypted equipment data using corresponding decryption key.

52. The electronic device of claim 47, wherein the electronic device is processed by the first processing equipment.

53. The electronic device of claim 47, wherein the electronic device is processed by second processing equipment which obtains equipment data from the first processing equipment.

54. The electronic device of claim 53, wherein the electronic device is processed by second processing equipment according to decrypted equipment data.

55. The electronic device of claim 53, wherein the electronic device is processed by second processing equipment which comprises a decryption unit able to decrypt the encrypted equipment data.

56. A method of managing equipment data distribution, comprising:
providing processing equipment equipped with a storage unit storing equipment data thereof;
receiving a first request for the equipment data, wherein the first request comprises identification data;
validating the identification data;
retrieving the equipment data from the storage unit and encrypting the equipment data when the identification data is validated; and
transferring the encrypted equipment data to an external system.

57. The method of claim 56, wherein the equipment data comprises recipe data.

58. The method of claim 56, wherein the equipment data comprises equipment parameters.

59. The method of claim 56, further receiving a second request for a decryption key for the encrypted equipment data, validating the second request, and providing the decryption key.

60. The method of claim 59, further retaining a record of the first and second requests.

61. The method of claim 59, further generating an alarm signal when receiving an invalidated request.

62. The method of claim 56, wherein the external system comprises an external storage device.

63. The method of claim 56, wherein the external system comprises a shop floor control system in a manufacturing environment

64. The method of claim 56, further sending the encrypted equipment data to a content management system.

65. The method of claim 56, further utilizing the encrypted equipment data to generate a technical document.

66. The method of claim 56, further utilizing the encrypted equipment data to generate operating instructions.
